(19) United States
(12) Patent Application Publication
(10) Pub. No.: US 2009/0262264 A1
(43) Pub. Date: Oct. 22, 2009

(54) DISPLAY DEVICE PROVIDING OPTIONAL INDEPENDENT DISPLAY

(75) Inventor: Hung-Huei Yu, Taipei (TW)

Correspondence Address: Muncy, Geissler, Olds & Lowe, PLLC, P.O. BOX 1364, FAIRFAX, VA, 22038-1364, US

(73) Assignee: SHUTTLE INC.

(21) Appl. No.: 12/106,789

(22) Filed: Apr. 21, 2008

(51) Int. Cl. H04N 5/64

(52) U.S. Cl. 348/836; 348/E05.128

(57) ABSTRACT

A display device providing optional independent display includes a chassis and a display screen located on the chassis. The chassis has an image processing device to provide first image information to the display screen and an image receiving device. The image receiving device is connected to an image output device of an external processor through a signal linking means. The display screen can function in a linking state by connecting to the external processor to display second image information stored and output from the external processor and a separating state to display independently the first image information. Thus the display screen can perform image information display function whether in the linking state by connecting to the external processor or in the separating state independent of the external processor.

### FIELD OF THE INVENTION

The present invention relates to a display device and particularly to a detachable display device providing optional independent display.

### BACKGROUND OF THE INVENTION

These days computer systems are widely used in people's life such as personal computers. A personal computer generally has a data processing unit to perform processing and store information, an input device to allow users to enter commands into the data processing unit and an output device to present information in the data processing unit. Display screen is one of the commonly used output devices.

A conventional display screen is linked to the data processing unit through a connection line via a Digital Visual Interface (DVI) or Video Graphic Array (VGA) to receive image information from the data processing unit. Such a linking approach is constrained by the physical length of the connection line. Hence the display screen has to be installed close to the data processing unit. As the traditional CRT display (Cathode Ray Tube display) for analog transmission is gradually replaced by TFT-LCD (Thin-Film Transistor Liquid-Crystal Display), the display screen is lighter and more compact. As a result, requirement for adding a display screen on portable electronic products increases significantly. Although the TFT-LCD is lighter and more compact, and is easier to carry and move, it is still restricted by the connection line for transmission. Hence its installing location related to the data processing unit cannot be altered as desired. To overcome this constraint, novel communication protocols adopted wireless technology such as infrared rays or Bluetooth have been developed. Reference can be found in U.S. Pat. Nos. 7,183,999, 6,784,855, 6,512,670, 6,028,764 and Publication No. 20050289631. They all adopt a wireless transmission means to allow the display screen to receive image information from the data processing unit. Therefore users can move the display screen as desired within the wireless transmission range. And application capability can be greatly enhanced. However, on either wired or wireless transmission, the display screen has to get the image information from the data processing unit. In the event that the distance is beyond the wireless transmission range, or the data processing unit is shutdown, the display screen cannot display any image information. Hence the display screen is merely an ancillary device and can provide only limited applications.

### SUMMARY OF THE INVENTION

The primary object of the present invention is to provide a display screen capable of presenting image information whether it is linked to a data processing unit or in an independent state, therefore can expand the application thereof. To achieve the foregoing object, the invention provides a detachable display screen to offer optional independent display. It includes a chassis and a display screen located on the chassis. The chassis has an image processing device to provide a first image information to the display screen and an image receiving device. The image receiving device is connected to an image output device of an external processor through a signal linking means. The display screen can function in a linking state by connecting to the external processor to display second image information stored and output from the external processor and a separating state to display independently the first image information.

In an embodiment of the invention the chassis further includes a first detection device to detect the linking condition of the image receiving device and the external processor.

In another embodiment the external processor has a holding zone for installation of the chassis. And the chassis has a second detection device to detect installing condition of the chassis on the holding zone.

The display device according to the invention can be in the linking state to display the second image information stored in the external processor or in the separating state to display independently the first image information depending on whether it is linked to the external processor or the chassis is installed on the holding zone. When the display device does not receive the second image information from the external processor it can independently display the first image information. Thus it can overcome the constraint occurred to the conventional display device that has to be linked to the external processor to display image information. As a result, the display device of the invention can provide more comprehensive applications.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic block diagram of an embodiment of the display device providing optional independent display of the invention.

FIG. 2 is a schematic block diagram of another embodiment of the display device providing optional independent display of the invention.

FIGS. 3A and 3B are schematic views of another embodiment of the invention in a use condition.

FIGS. 4A and 4B are schematic views of yet another embodiment of the invention in a use condition.

### DETAILED DESCRIPTION OF THE PREFERRED EMBODIMENTS

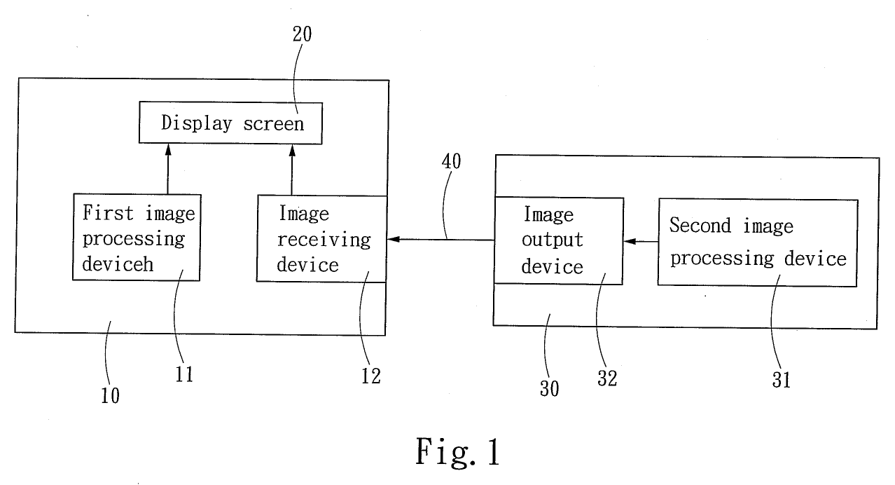

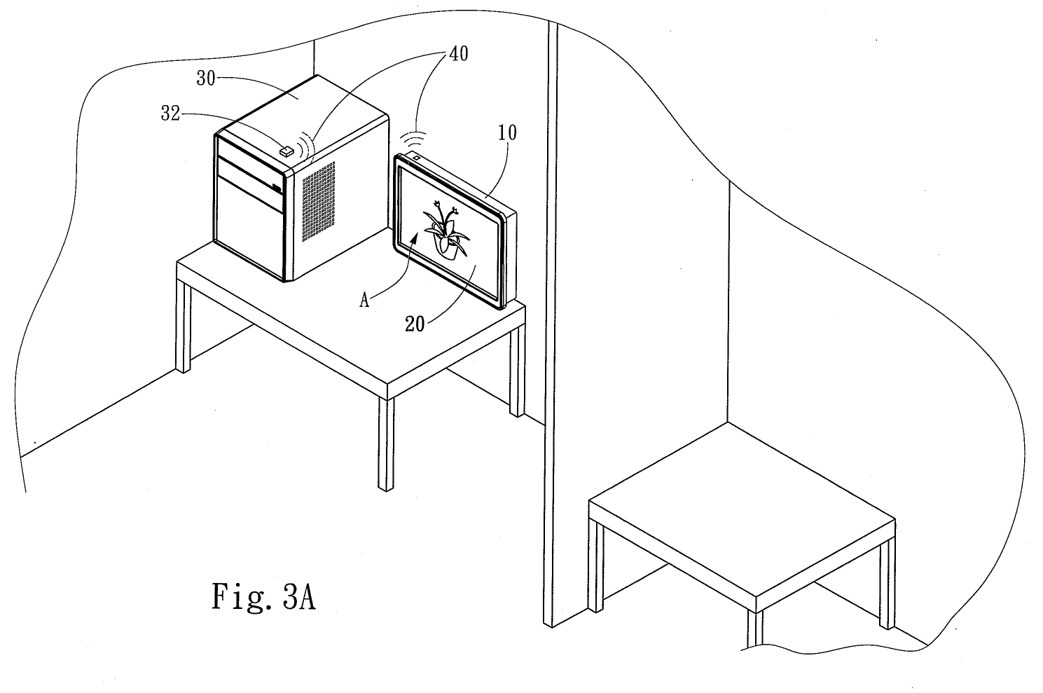

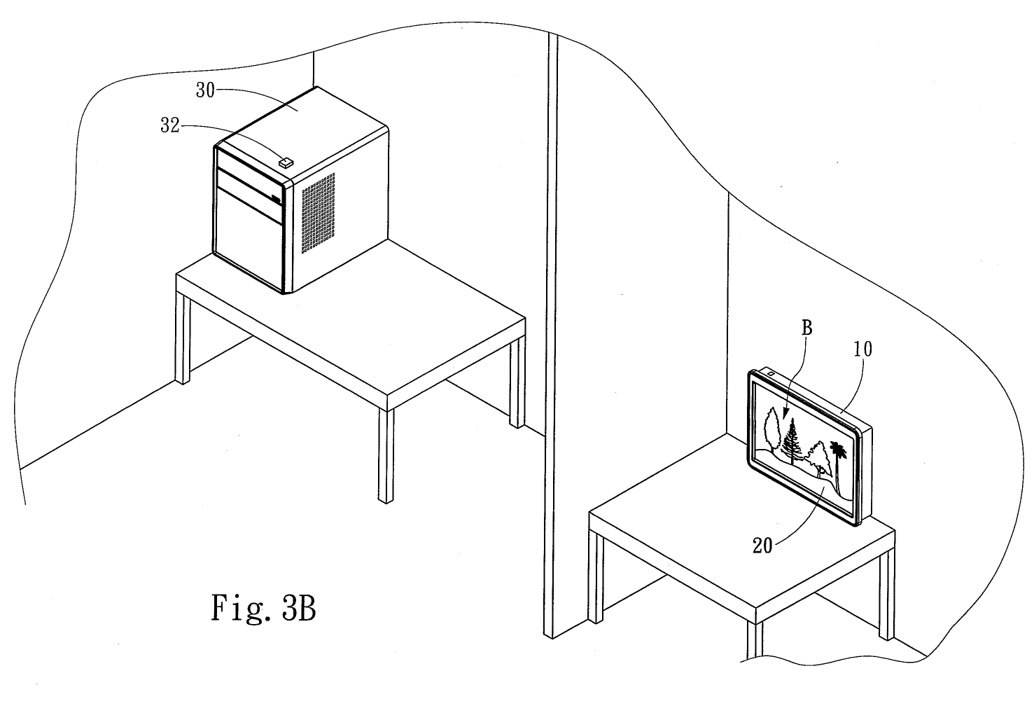

Please refer to FIGS. 1, 3A and 3B for the structure of an embodiment of the invention. The display device providing optional independent display of the invention includes a chassis 10 and a display screen 20 located on the chassis 10. The chassis 10 has a first image processing device 11 to provide a first image information B to the display screen 20 and an image receiving device 12. The image receiving device 12 is linked to an external processor 30 through a signal linking means 40. The external processor 30 may be a computer system, an image broadcasting equipment or an image game player that can process and output images. The external processor 30 has a second image processing device 31 to generate and store a second image information A and an image output device 32 linking to the second image processing device 31 to transmit the second image information A to the image receiving device 12. The display screen 20 is linked to the external processor 30 through the signal linking means 40 to display a linking state of output of the second image information A stored in the external processor 30, and a separating state for independently displaying the first image information B. In the invention the signal linking means 40 is a signal connection means to bridge the chassis 10 and the external processor 30. Signal transmission may include data signals and power signals. The signal linking means 40 may be a physical connection interface such as a Universal Series Bus Module (USB module), IEEE 1394, DVI, VGA or the like, or a wireless communication module such as a Bluetooth Module, Infrared Ray Module, Wireless USB Module, IEEE 802.11 or the like.

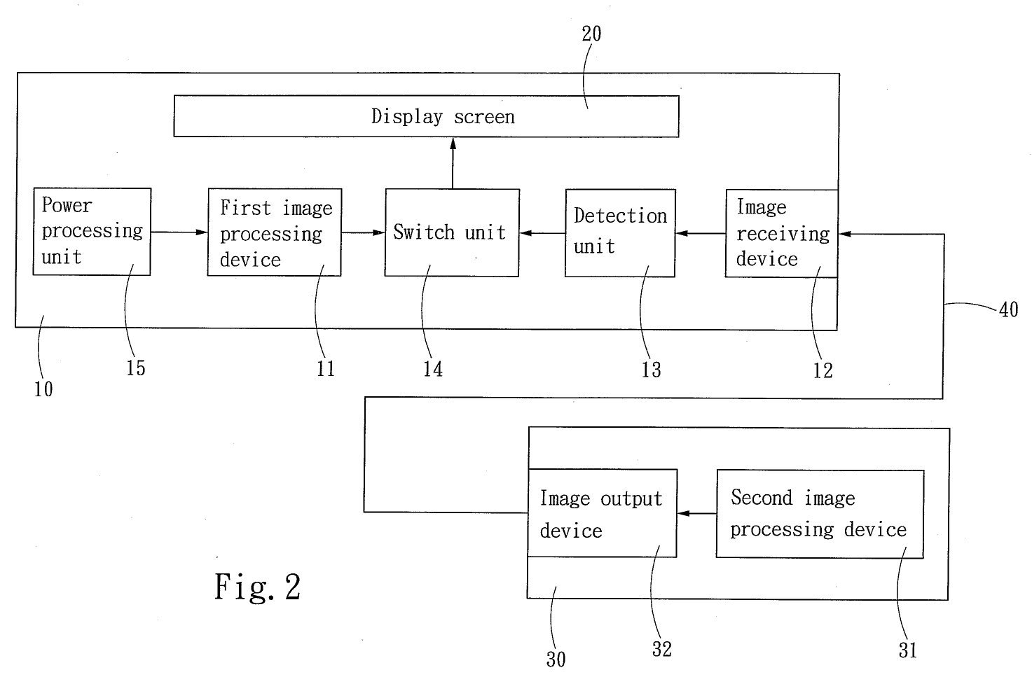

Refer to FIG. 2 for the structure of another embodiment of the invention. In this embodiment the chassis 10 further includes a detection unit 13 to detect signal linking condition between the image receiving device 12 and the image output device 32 of the external processor 30 and a switch unit 14 located between the detection unit 13 and the first image processing device 11. The switch unit 14 controls switching of the linking state and the separating state of the display screen 20. Moreover, the chassis 10 may also have an independent power processing unit 15 to provide electric power required for operation of the chassis 10. The electric power may be provided through a power storage element (such as a battery), an independent power cord (not shown in the drawings) or power signals from the external processor 30.

Referring to FIGS. 2 and 3A, when the image receiving device 12 is linked to the image output device 32 through the signal linking means 40 to get the second image information A, the detection unit 13 generates a detection signal to the switch unit 14. The switch unit 14 stops the first image processing device 11 to provide the first image information B to the display screen 20, and allows the display screen 20 to display the second image information A from the external processor 30 like a conventional display device. In the event that the chassis 10 is located at a great distance from the external processor 30, and linking between the image receiving device 12 and the image output device 32 is not established (referring to FIG. 3B), the detection unit 13 detects no signal linking between the image receiving device 12 and the image output device 32, then no detection signal is provided by the detection unit 13 to the switch unit 14. The first image processing device 11 sends the generated first image information B to the display screen 20 to be displayed. Thus the invention is in the separating state and functions independently. In addition, the switch unit 14 may also be switched manually between the linking state and the separating state according to user's requirement to offer more flexible operation.

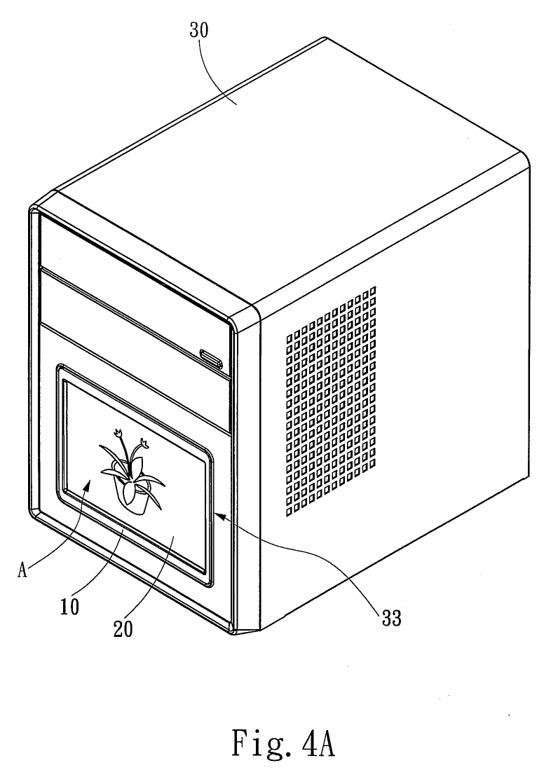

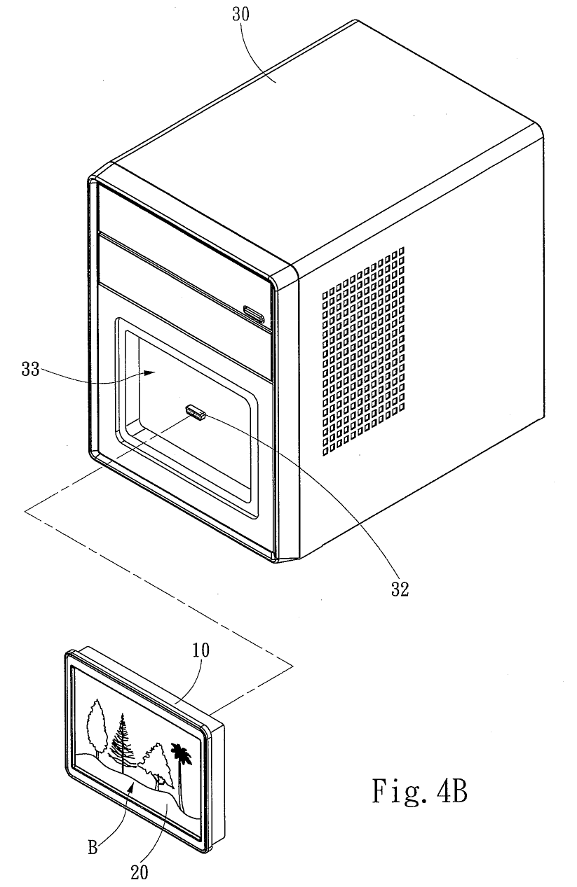

Refer to FIGS. 4A and 4B for yet another embodiment of the invention in a use condition. In this embodiment the display device is installed on the external processor 30. The external processor 30 has a holding zone 33 for installation of the chassis 10. The image output device 32 corresponding to the image receiving device 12 may also be located in the holding zone 33 to allow the chassis 10 installed on the installation zone 33 to receive the second image information A from the external processor 30.

As a conclusion, the display screen 20 of the display device providing optional independent display of the invention can be linked to the external processor 30 in the linking state to display the second image information A, and also can be in the separating state with the first image processing device 11 located on the chassis 10 to generate independently the first image information B. Thus it does not rely on the image signals transmitted from a computer system to display images as the conventional display device does. When the invention is in the separating state, such as in the applications of an electronic photo frame or portable image player, it can independently process and display the first image information B. Hence the applicability of the display device is greatly enhanced. As a result, the display device is no longer an ancillary output device of the traditional computer system, but can independently perform image processing and displaying functions. It provides a significant improvement over the conventional display device.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A display device providing optional independent display, comprising:
a chassis and a display screen located on the chassis;
an image processing device located in the chassis to provide a first image information to the display screen; and
an image receiving device which is located in the chassis and linked to an image output device of an external processor through a signal linking means;
wherein the display screen has a linking state by linking to the external processor to display a second image information stored and output from the external processor and a separating state to independently display the first image information.

2. The display device providing optional independent display of claim 1, wherein the chassis further has a detection unit to detect linking conditions between the image receiving device and the image output device.

3. The display device providing optional independent display of claim 1, wherein the external processor has a holding zone for installation of the chassis.

4. The display device providing optional independent display of claim 1, wherein the chassis further has a switch unit to control switching of the linking state and the separating state of the display screen.

5. The display device providing optional independent display of claim 1, wherein the signal linking means is a physical connection interface.

6. The display device providing optional independent display of claim 1, wherein the signal linking means is a wireless communication module.

7. The display device providing optional independent display of claim 1, wherein the chassis further has a power processing unit.
